(19) United States
(12) Patent Application Publication
(10) Pub. No.: US 2026/0076402 A1
(43) Pub. Date: Mar. 19, 2026

(54) COOLING DIE AND METHOD FOR PRODUCING MEAT-LIKE FOOD

(71) Applicant: Nisshin Seifun Group Inc., Tokyo (JP)

(72) Inventors: Masashi YOSHIDA, Fujimino-shi (JP); Noriyuki SHIBAMOTO, Fujimino-shi (JP)

(73) Assignee: Nisshin Seifun Group Inc., Tokyo (JP)

(21) Appl. No.: 19/110,700

(22) PCT Filed: Feb. 9, 2024
(86) PCT No.: PCT/JP2024/004442

§ 371 Date: Mar. 11, 2025

(30) Foreign Application Priority Data
Feb. 17, 2023 (JP) 2023-023831

(51) Int. Cl. A23P 30/20

(52) U.S. Cl. CPC A23P 30/20

(57) ABSTRACT

Provided is a cooling die 12 for producing a meat-like food product. The cooling die 12 is disposed downstream, in an extrusion direction X, of an extrusion apparatus 31 that extrudes an introduced protein ingredient as an extrudate 33 with an oriented fibrous structure, has an internal portion with a channel 14 through which the extrudate 33 moves, and is configured to cool the extrudate 33 that is moving in the channel 14. The cooling die 12 includes a loosening unit 39 that is disposed in a part of the channel 14 in a movement direction X of the extrudate 33. The loosening unit 39 occupies at least a part of a cross section of the channel 14 in a direction that is orthogonal to the movement direction X, and has a plurality of through holes 32 that extend through the loosening unit 39 in the movement direction X. The extrudate 33 is loosened by passing through the plurality of through holes 32.

### TECHNICAL FIELD

The present invention relates to a cooling die and a method for producing a meat-like food product.

### BACKGROUND ART

Conventionally, there are known techniques for obtaining meat-like food products with oriented fibrous structures by heating and kneading protein components using an extrusion apparatus such as an extruder and then extruding the resultant through a cooling die (Patent Literatures 1 to 3).

Patent Literature 1 describes a cooling nozzle including a product channel having an annular transverse cross section the circumference of which is closed over a wide range with the exception of at least one recess. Patent Literature 2 describes a cooling die including a channel having a substantially constant transverse cross section that is a continuous loop substantially along the entire length of the die. Patent Literature 3 describes an extrusion apparatus including die holes that are aligned with extrusion screws.

### CITATION LIST

### Patent Literature

Patent Literature 1: US 2021/0219593A1
Patent Literature 2: US 2015/0044334A1
Patent Literature 3: WO 2006/019320A1

### SUMMARY OF INVENTION

However, none of the cooling dies and methods for producing meat-like food products using the same described in Patent Literatures 1 to 3 fully considered eliminating the hardness of the texture of meat-like food products and the difficulty in loosening the meat-like food products.

Accordingly, it is an object of the present invention to provide a cooling die and a method for producing a meat-like food product using the same that are capable of addressing the above-descried issues of conventional techniques.

The present invention provides a cooling die for producing a meat-like food product, the die being disposed downstream, in an extrusion direction, of an extrusion apparatus that extrudes an introduced protein ingredient as an extrudate with an oriented fibrous structure, having an internal portion with a channel through which the extrudate moves, and being configured to cool the extrudate that is moving in the channel, including:
a loosening unit that is disposed in a part of the channel in a movement direction of the extrudate,
wherein the loosening unit occupies at least a part of a cross section of the channel in a direction that is orthogonal to the movement direction, and has a plurality of through holes that extend through the loosening unit in the movement direction, and
the extrudate is loosened by passing through the plurality of through holes.

The present invention further provides a method for producing a meat-like food product, using an extrusion apparatus that extrudes an introduced protein ingredient as an extrudate with an oriented fibrous structure and the above-described cooling die.

### BRIEF DESCRIPTION OF DRAWINGS

FIG. 1 is a schematic view of an extrusion apparatus and a cooling die in an embodiment of the present invention.

FIG. 2 is a schematic view of a cross section of a loosening unit in an example of the embodiment, taken along a direction that is orthogonal to an extrusion direction.

FIG. 3 is a schematic view of cross sections of the loosening unit in other examples of the embodiment, taken along a direction that is orthogonal to the extrusion direction.

### DESCRIPTION OF EMBODIMENT

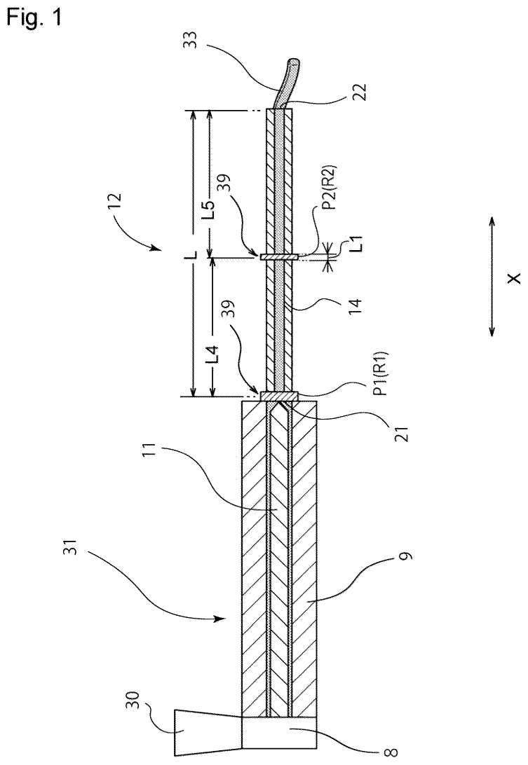

Hereinafter, a preferred embodiment of the present invention will be described. FIG. 1 shows a schematic view of an extrusion apparatus 31 and a cooling die 12 according to an embodiment of the present invention. In the example shown in FIG. 1, the cooling die 12 is disposed downstream, in an extrusion direction X, of the extrusion apparatus 31 through which a protein ingredient introduced through a hopper 30 is extruded as an extrudate 33.

Vegetable and animal proteins can be used as the protein ingredient, and the protein ingredient preferably contains a vegetable protein. In the present invention, the protein ingredient may or may not contain animal proteins. The animal proteins may be, for example, livestock meat and/or fish meat, insects, or cultured cells. The protein ingredient serving as a vegetable protein source may be legume proteins, grain proteins, potato proteins, proteins extracted from seeds (nuts), proteins extracted from algae, or the like. The legume proteins may be soybean proteins such as defatted soybean flour, concentrated soybean protein, isolated soybean protein, or extracted soybean protein derived from soybeans, pea protein, broad bean protein, chickpea protein, or mung bean protein. The grain proteins may be wheat protein such as gluten, rice protein, oats protein, rapeseed protein, potato protein, or the like. In the present invention, the protein ingredient is preferably at least one selected from legume proteins and grain proteins. The protein ingredient is such that, from the viewpoint of forming a fibrous structure, the proportion of the vegetable proteins is preferably 10 mass % or more, more preferably 20 mass % or more, and even more preferably 40 mass % or more, and may be 50 mass % or more, of proteins constituting the protein ingredient.

In the present invention, from the viewpoint of realizing ease of loosening and softness of a meat-like food product, it is preferable to feed water together with the protein ingredient into the extrusion apparatus 31 and to knead the protein ingredient and the water in the extrusion apparatus 31. From the viewpoint of increasing the softness and the ease of loosening and realizing the shape retainability, the amount of water used is preferably 70 to 200 parts by mass, and more preferably 90 to 180 parts by mass, with respect to 100 parts by mass of the protein ingredient. Also, the amount of water used is preferably 45 to 240 parts by mass, and more preferably 60 to 200 parts by mass, with respect to 100 parts by mass of proteins in the protein ingredient.

In addition to water and the protein ingredient, other ingredients may be fed into the extrusion apparatus 31 as ingredients of the meat-like food product. The other ingredients may be starch, grains, minerals, dietary fiber, fat, emulsifiers, thickeners, dyes, amino acids, peptides, or the like. The proportion of the protein ingredient and water in total is preferably 10 mass % or more, and more preferably 20 mass % or more, and may be 40 mass % or more, of all ingredients of the meat-like food product. The proportion of proteins and water in total is preferably 10 mass % or more, and more preferably 20 mass % or more, and may be 40 mass % or more, of all ingredients of the meat-like food product. The aforementioned water and protein ingredient as well as other ingredients added as necessary may be mixed in the extrusion apparatus 31, or may be pre-mixed before being fed into the extrusion apparatus 31.

An extruder can be used without any particular limitation as the extrusion apparatus 31. In FIG. 1, an extruder, which is an example of the extrusion apparatus 31, typically includes a hollow cylindrical barrel 9 (also called a cylinder) configured to contain a processing target material, a screw 11 disposed inside the barrel 9 and configured to be driven in rotation by a motor or other drive source, and a feeder 8 through which the processing target material from the hopper 30 is fed into the internal portion of the barrel 9. The cooling die 12 of the present invention is preferably disposed at the outlet of the barrel 9 of the extruder. The processing target material fed from the feeder 8 of the extruder into the internal portion of the barrel 9 moves toward the die 12 while being compressed by the screw 11 and is extruded into the die 12. A heating means (not shown) such as a cartridge heater may be attached around the barrel 9 to enable heating of the processing target material inside the barrel. The screw 11 of the extruder may be of either a single or twin shaft type, but the screw is preferably of a twin shaft type.

The extrusion apparatus 31 of this embodiment kneads ingredients, including the protein ingredient and preferably water, with application of heat. The kneading temperature in the extrusion apparatus 31 is not particularly limited as long as it is a temperature normally employed for meat-like food products, but usually the temperature at the tip of the barrel 9 during kneading is preferably 100 to 200° C., and more preferably 120 to 180° C.

The cooling die 12 is disposed downstream, in the extrusion direction, of the extrusion apparatus 31. The internal portion of the cooling die 12 has a channel 14 through which the extrudate 33 moves, and the extrudate 33 extruded by the extrusion apparatus 31 flows into the channel 14 of the cooling die 12. The pressure of the extrudate 33 flowing into the channel 14 is not particularly limited, but from the viewpoint of realizing stable production and aligning fiber orientation inside the cooling die 12, the pressure is, for example, preferably 0.5 to 10 MPa. and more preferably 1.0 to 5.0 MPa. The temperature of the extrudate 33 flowing into the channel 14 is preferably 120 to 200° C., and more preferably 140 to 180° C.

The cooling die 12 cools the extrudate 33 that is moving in the channel 14. The cooling of the extrudate 33 in the cooling die 12 may be performed by subjecting the extrudate 33 to an external and intentional cooling operation or by simply moving the extrudate 33 in a movement direction X. The former is also referred to as forced cooling and the latter as natural cooling. One method of forced cooling is to provide a refrigerant flow path around the outer circumferential face of the channel 14 in the cooling die 12 and pass a refrigerant through the refrigerant flow path. The cooling die may be referred to as a “cooling nozzle”.

The channel 14 of the cooling die 12 has an inlet 21 into which the extrudate 33 extruded from the extrusion apparatus 31 flows, and an outlet 22 from which the extrudate 33 flowing from the inlet 21 and through the channel 14 is discharged. The movement direction X in the channel 14 from the inlet 21 to the outlet 22 is usually the same as the extrusion direction in the extrusion apparatus 31. The process of extrusion and movement by the extrusion apparatus 31 and the cooling die 12 causes the extrudate 33 to have an oriented fibrous structure. The fibrous structure is preferably oriented along the movement direction X.

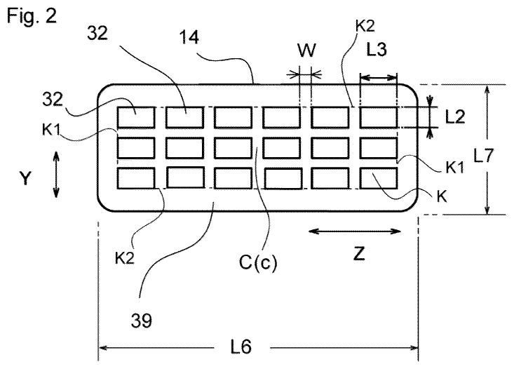

A cross section of the channel 14 in a direction that is orthogonal to the movement direction X (hereinafter, the “cross section in the direction that is orthogonal to the movement direction X” is also simply referred to as “the cross section”) may have a rectangular, annular, polygonal, circular, or other shape. For example, the cross section of the channel 14 may have a shape that is long in one direction, or may have an annular shape or an interrupted annular shape as described in Patent Literatures 1 and 2. As for these shapes of the cross section of the channel 14, the length of the cross section in the longitudinal direction (e.g., if the external shape of the cross section of the channel 14 conforms to the external shape of the loosening unit, see L6 in FIG. 2) is preferably 10 to 100 mm, and more preferably 50 to 90 mm. The length of the cross section in the direction that is orthogonal to the longitudinal direction (e.g., if the external shape of the cross section of the channel 14 conforms to the external shape of the loosening unit, see L7 in FIG. 2) is preferably 3 to 50 mm, and more preferably 5 to 40 mm. If the cross section of the channel 14 has an annular shape or an interrupted annular shape as described in Patent Literatures 1 and 2, the length in the circumferential direction and the length in the radial direction respectively correspond to the length in the longitudinal direction and the length in the direction that is orthogonal to the longitudinal direction.

The channel 14 of this embodiment is preferably configured such that the cross section thereof is in the shape of a single hole from the inlet 21 to the outlet 22, except for the location of a loosening unit 39, which will be described later, from the viewpoint of enhancing the effect of providing the loosening unit 39. For example, the channel 14 from the inlet 21 to the outlet 22, except for the location of the loosening unit 39, may be formed in a straight or curved shape, and more preferably formed in a straight shape, oriented in the movement direction X without any branch or merging portions in a side view and/or a plan view.

The cross section of the channel 14, except for the location of the later-described loosening unit 39, may have substantially constant dimensions and/or shape. The state in which the cross section has substantially constant dimensions may refer to, for example, a state in which a difference between the Z-direction dimensions, Y-direction dimensions, and/or the cross-sectional areas of any two cross sections out of the three cross sections taken at the three locations that are spaced apart from each other by a quarter of an entire length L of the channel 14 in the movement direction X is 10% or less (preferably 5% or less). The state in which the cross section has a substantially constant shape refers to a state in which the cross section continues to have the same type of shape such as a rectangular, annular, elliptical, or circular shape, with a difference between the areas of any two cross sections out of the three cross sections that are not enlarged or reduced or that are enlarged or reduced being 5% or less (preferably 3% or less).

The cooling die 12 includes a loosening unit 39 that is disposed in a part of the channel 14 in the movement direction of the extrudate 33. The loosening unit 39 occupies at least a part of the cross section of the channel 14 in the direction that is orthogonal to the movement direction X, and has a plurality of through holes 32 that extend through the loosening unit 39 in the movement direction X. The through holes 32 constitute the loosening unit 39. The extrudate 33 is loosened by passing through the plurality of through holes 32. The manner of being loosened in the “loosening unit 39” herein may be a manner in which the extrudate 33 is passed through the loosening unit 39 to be divided into a plurality of flows that are extruded in the X direction, downstream of the location of the loosening unit 39 in the X direction. It is permissible for the plurality of flows obtained by dividing the extrudate 33 into a plurality of portions to merge after passing through the loosening unit 39, downstream of the loosening unit 39 in the movement direction X.

As can be seen from the fact that the loosening unit 39 is located at a portion of the channel 14 in the movement direction X, the dimension of the loosening unit in the movement direction X in the channel 14 is smaller than the entire length L of the channel 14 in the direction X. As described above, the loosening unit 39 has the plurality of through holes 32 that extend through the loosening unit 39 in the movement direction X. The loosening unit 39 may have, for example, a net shape, a lattice shape, a sieve shape, a flat plate shape having the plurality of through holes 32, a cone shape having the plurality of through holes 32, or a pyramid shape having the plurality of through holes 32. The material of the loosening unit 39 may be, but is not particularly limited to, iron, copper, titanium, stainless steel, ceramics, plastic or other synthetic resin, or the like.

The state in which the loosening unit 39 occupies at least a part of the cross section of the channel 14 means a state in which when the loosening unit 39 is located in the channel 14, the area of the loosening unit 39 (including the area of the through holes 32) occupies a certain portion or more of an area Sf (not shown) of the cross section of the channel 14 at the location of the through holes 32 of the loosening unit 39. In the cross section of the channel 14, the proportion of the area of the loosening unit 39 is preferably 80% or more, more preferably 90% or more, even more preferably 95% or more, and even more preferably 99% or more, and may be 100%, of the area Sf of the cross section.

The shape of each through hole 32 in the cross section in the direction that is orthogonal to the extrusion direction X may be, but is not particularly limited to, a rectangular, circular, elliptical, or polygonal shape. As for these shapes of the through hole 32 in the cross section, a ratio L3/L2 of a length L3 (see FIG. 2) of the through hole 32 in a horizontal direction Z in the cross section to a length L2 (see FIG. 2) thereof in a height direction Y is not particularly limited, but the ratio is, for example, preferably 0.15 to 3.0, more preferably 0.2 to 2.0, and even more preferably 0.6 to 1.5, from the viewpoint of easily obtaining a meat-like food product with excellent softness and ease of loosening. In the case in which the cross section of the channel 14 has a shape that is long in one direction as shown in FIG. 2, the loosening unit 39 preferably has a plurality of through holes 32 that are arranged side by side along the longitudinal direction (which is the same as the Z direction in FIG. 2) of the cross section of the channel 14, and preferably has three or more through holes 32 that are arranged side by side along the longitudinal direction.

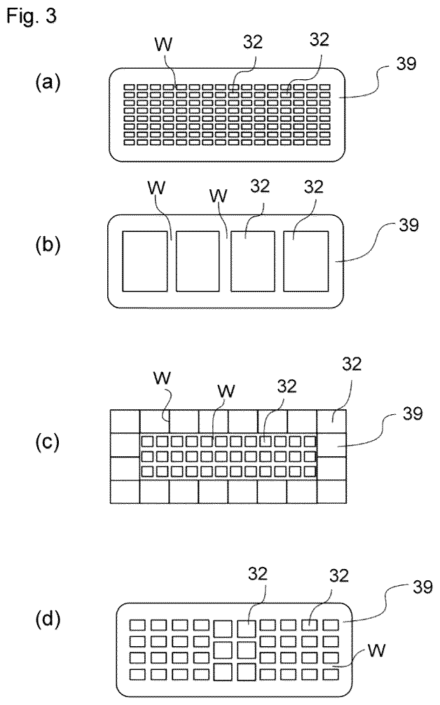

The shape of the loosening unit 39 is not limited to that shown in FIG. 2, and the through holes may be large or smaller as in (a) and (b) in FIG. 3. Furthermore, the plurality of through holes 32 in the loosening unit 39 may have different areas, shapes, or intervals W as in (c) and (d).

The position of the through holes 32 in the cross section of the channel 14 is not limited, but if the shape of the cross section has a center of gravity, there is preferably at least one through hole 32, and more preferably two or more through holes 32, at least two-thirds of the area of which is contained within a circumference having a diameter passing through the center of gravity of the cross section and having a length that is one-half of the longest line segment passing through the cross section. The proportion of areas S (opening areas in the cross section, not shown, the same applies below) of the through holes 32 in total in the cross section is preferably 35 to 90% of the area Sf of the cross section of the channel 14 at the location of the through holes 32 from the viewpoint of realizing excellent softness and ease of loosening, and more preferably 45 to 75% of the area Sf from the viewpoint of the balance between the softness, the looseness, and the shape retainability.

The loosening unit 39 is preferably disposed upstream of the outlet 22 in the channel 14 from the viewpoint of enhancing the shape retainability while improving the softness and the ease of loosening.

The loosening unit 39 is preferably disposed in a region across distances, from the inlet 21, corresponding to 0 to 90% of the entire length L of the channel 14 from the above-mentioned viewpoints, preferably disposed in a region across distances, from the inlet, corresponding to 20 to 80% of the entire length from the viewpoint of realizing excellent softness and looseness as well as shape retainability of a meat-like food product, and more preferably disposed in a region across distances, from the inlet, corresponding to 30 to 70% of the entire length.

Note that the distance herein refers to the length of the path in the case in which the channel 14 has a bend or curve.

One loosening unit 39 may be disposed in the channel 14, or two or more loosening units may be arranged along the movement direction X. If a plurality of loosening units 39 are arranged along the movement direction X in the channel 14, they may be adjacent to each other in the direction X, but are preferably spaced apart from each other along the movement direction X from the viewpoint of obtaining the effect resulting from characteristics of the shape of each loosening unit and maintaining the shape retainability. The number of loosening units 39 in the channel 14 is preferably 2 to 5, and more preferably 2 to 4.

In particular, it is preferable that one or more loosening units 39 are arranged in a region R1 across distances, from the inlet 21, corresponding to 0 to 30%, and more preferably 0 to 25%, of the entire length L of the channel 14 and, furthermore, one or more loosening units 39 are arranged in a region R2 as well across distances, from the inlet 21, corresponding to 20 to 80%, and more preferably 30 to 70%, of the entire length L of the channel 14, from the viewpoint of obtaining a meat-like food product with excellent softness and looseness as well as excellent shape retainability.

If two or more loosening units 39 are arranged along the movement direction X with respect to the entire length L of the channel 14, a distance L4 (see FIG. 1) in the movement direction X between two loosening units 39 that are neighboring to each other in the movement direction X is preferably 20 to 100% of the entire length L of the channel 14, and more preferably 30 to 90% thereof, from the viewpoint of easily realizing both the softness and ease of loosening and the shape retainability of a meat-like food product. If three or more loosening units 39 are arranged along the movement direction X with respect to the entire length L of the channel 14, it is sufficient that the distance between two loosening units 39 that are neighboring to each other in the movement direction X is within the above-mentioned range.

If the channel 14 has two or more loosening units 39 that are spaced apart from each other along the movement direction X, the number of through holes 32 of a loosening unit that is located on the downstream side in the extrusion direction X per 10 cm² of the area of the cross section of the channel 14 is preferably the same as or larger than the number of through holes 32 of a loosening unit 39 that is located on the upstream side per 10 cm² of the area of the cross section of the channel 14, from the viewpoint of realizing softness and ease of loosening of a meat-like food product. If three or more loosening units 39 are arranged, it is sufficient that two of these loosening units 39 have the above-mentioned relationship (the same applies below).

If the channel 14 has two or more loosening units 39 that are spaced apart from each other along the movement direction X, an average value of the area S per through hole 32 of a loosening unit 39 that is located on the downstream side in the extrusion direction X, in the cross section in the direction that is orthogonal to the X direction, is preferably the same as or smaller than an average value of the area S per through hole 32 of a loosening unit 39 that is located on the upstream side, from the viewpoint of softness and ease of loosening of a meat-like food product. If the cross-sectional area changes along the movement direction X, the area S is the smallest area in the same direction.

If the channel 14 has two or more loosening units 39 that are spaced apart from each other along the movement direction X, an average value of a ratio (S/Sf) of the area S of one through hole 32 of a loosening unit 39 that is located on the downstream side in the extrusion direction X to the area Sf of the channel 14 is preferably the same as or smaller than an average value of the area ratio S/Sf of that of one through hole 32 of a loosening unit 39 that is located on the upstream side, from the viewpoint of softness and ease of loosening of a meat-like food product.

The following is a further description of a preferred configuration of the loosening unit 39. If the channel 14 has a plurality of loosening units 39, it is sufficient that any one of the loosening units 39 satisfies the following numerical range. In particular, it is preferable that a loosening unit 39 that is located in the region R2 satisfies the following preferred upper limit and/or lower limit. Furthermore, it is preferable that each loosening unit 39 satisfies the following preferred upper limit and/or lower limit.

In the loosening unit 39, the ratio (S/Sf) of the area S of one through hole 32 to the area Sf is preferably 40% or less, and more preferably 10% or less, from the viewpoint of softness and ease of loosening of a meat-like food product. The ratio (S/Sf) is usually preferably 0.3% or more, preferably 0.5% or more, and more preferably 1.0% or more, and may be 3% or more, from the viewpoint of stable production and shape retainability of a meat-like food product. From these viewpoints, the ratio S/Sf is preferably 0.3 to 40%, more preferably 0.5 to 10%, and even more preferably 1.0 to 10%, and may be 3 to 10%. Furthermore, it is preferable that an average value of the areas S of the through holes 32 in the loosening unit 39 is within the above-mentioned range of S/Sf.

The area S of one through hole 32 of the loosening unit 39 is preferably 1 to 300 mm² from the viewpoint of further improving the softness and the ease of loosening and realizing stable production, and more preferably 10 to 70 mm² from the viewpoint of realizing excellent shape retainability in addition to the above-mentioned effect.

The number of through holes 32 in the loosening unit 39 is preferably 2 to 160 per 10 cm² of the cross-sectional area of the cross section (the cross section in the direction that is orthogonal to the extrusion direction X) of the channel, from the viewpoint of further improving the softness and the ease of loosening and realizing stable production.

An interval W (see FIG. 2, etc.) between the through holes 32 that are neighboring to each other in the loosening unit 39 is, for example, preferably 6.0 mm or less, more preferably 3.0 mm or less, and even more preferably 2.0 mm or less, from the viewpoint of softness and ease of loosening of a meat-like food product. The interval W between the through holes 32 is, for example, preferably 0.5 mm or more, and more preferably 1.0 mm or more, from the viewpoint of shape retainability of a meat-like food product. From these viewpoints, the interval W between the through holes 32 that are neighboring to each other is preferably 0.5 to 6.0 mm, more preferably 1.0 to 3.0 mm, and even more preferably 1.0 to 2.0 mm. If the interval W is not constant in one loosening unit 39, the width W is an average of values obtained through measurement performed at 20 locations at random.

The ratio of the interval W (see FIG. 2, etc.) between the through holes 32 that are neighboring to each other to an area conversion radius Y1 of the area S of a through hole in the loosening unit 39 is, for example, preferably 0.2 to 1.4, more preferably 0.3 to 1.3, and even more preferably 0.4 to 1.1. The area conversion radius is a radius obtained through conversion assuming that the through hole is in shape of a perfect circle.

A length L1 (see FIG. 1) of the loosening unit 39 in the movement direction X is preferably 0.05 to 5% of a distance L5 (e.g., see FIG. 1 for a position P2 in the region R2) from the loosening unit 39 to the outlet 22 in the movement direction X, from the viewpoint of excellent softness and ease of loosening as well as stable production, and more preferably 0.1 to 3% of the distance L5 from the viewpoint of further improving the softness and the ease of loosening and realizing shape retainability.

The length L1 of the loosening unit 39 in the movement direction X is preferably 0.15 to 15 mm from the viewpoint of easily realizing softness and ease of loosening of a resulting meat-like food product as well as stable production, and more preferably 0.3 to 8 mm from the viewpoint of the balance between the softness, the ease of loosening, and the shape retainability.

The length L of the channel 14 may be, but is not limited to, preferably 3 M) to 2000 mm, and more preferably 400 to 1500 mm. The material temperature of the extrudate 33 at the outlet is preferably 40 to 120° C. The extrudate 33 discharged from the outlet 22 is cut into pieces with an appropriate size or otherwise processed.

The loosening unit may be installed as a plate, for example, by opening a portion of a peripheral wall constituting the channel, for example, a portion in the X direction of one or more of the top wall, the bottom wall, and the side walls, and inserting the plate into the opening. In that case, for example, the inserted plate and the channel opening for insertion are positioned in contact or with a small gap therebetween (not shown).

Through the above-described processing, a meat-like food product can be obtained. The obtained meat-like food product has excellent softness and ease of loosening. In an example, the size of the meat-like food product may be preferably, but is not limited to, 3 to 50 mm in thickness and 10 to 100 mm in width. The meat-like food product obtained in the present invention can be used as is or as an ingredient in processed foods as appropriate, as an imitation of fish, shrimp, or other seafood-derived meat or livestock meat (pork, chicken, beef), or the like. The meat-like food product obtained in the present invention has a good fiber loosening and soft texture, and thus, in particular, a chicken-like texture can be easily obtained.

### EXAMPLES

In the following examples, a rectangular-shaped loosening unit 39 shown in FIG. 2 was used. The arrangement of through holes in the loosening unit 39 was based on increasing or decreasing the number of through holes 32 aligned in the Y and Z directions from that in FIG. 2. The example in FIG. 2 shows the arrangement of the through holes 32 in a plate (c) below.

### Example 1

The extrusion apparatus 31 and the cooling die 12 in FIG. 1 were used. The length L of the channel 14 of the cooling die 12 in the movement direction X was 1100 mm. The inner wall of the channel 14 of the cooling die 12 was made of SUS304, and the channel 14 had a rectangular cylindrical shape whose cross section in the direction that was orthogonal to the extrusion direction X was 16 mm in the Y direction×64 mm in the Z direction as shown in FIG. 2. The loosening unit 39 used had a shape in which, when installed as the loosening unit 39 in the channel 14, the rectangular through holes 32 of the same shape as shown in FIG. 2 were arranged side by side in the Z and Y directions at intervals W therebetween. The thickness (length in the X direction) L1 of the loosening unit 39, the number of rows of the through holes 32, the number of holes per area, and the dimensions were as shown in Table 1. If there were a plurality of rows of the through holes in the Y direction, the number of through holes arranged in the Z direction was approximately equal in each row in the Y direction.

The loosening unit 39 was disposed in the channel 14 such that a center of gravity C (see FIG. 2) in a plan view of the loosening unit and a center c of an arrangement region K (indicated by the dotted line in FIG. 2) of through holes (the intersection of the center line extending in the Y direction and bisecting the length in the Z direction of the arrangement region K and the center line extending in the Z direction and bisecting the length in the Y direction of the arrangement region K) were at the same position when the loosening unit was viewed in plan view. The arrangement region K of through holes is a region defined by straight lines (dotted lines K1 in FIG. 2) extending in the Y direction along the outer edges in the Z direction of the through holes and straight lines (dotted lines K2 in FIG. 2) extending in the Z direction along the outer edges in the Y direction of the through holes 32, in the loosening unit 39 as shown in FIG. 2. The loosening unit 39(b) used was a plate (b) that was 1 mm in thickness, 30 mm in height, 75 mm in width, and made of SUS304. The loosening unit 39 was installed at the inlet 21 (P1) of the channel 14 of the cooling die 12 with the plate surface perpendicular to the extrusion direction X such that the through holes 32 extended in the extrusion direction X.

### Procedure for Producing High-Moisture Meat Substitute

A mixture was prepared by adding 150 parts by mass of water to 50 parts by mass of soybean protein (Fujipro CA manufactured by Fuji Oil Co., Ltd., protein content 90 mass % or more in anhydrous equivalent) and 50 parts by mass of wheat protein (WEIPRO Jacker Muhlen-und Nahrmittelwerke GmbH, protein content 72 mass % or more in anhydrous equivalent) serving as protein ingredients, and subjected to heat treatment with pressing and kneading using the extrusion apparatus 31, which was an extruder with a twin-shaft screw 11, at a temperature at the tip of the barrel of 160° C., after which the kneaded mixture was passed through the hollow cooling die 12 directly connected to the twin-shaft extruder to obtain a high-moisture meat substitute for tasting. The extrudate 33 flowed into the cooling die 12 at a temperature of 140 to 180° C. and a pressure of 1.0 to 5.0 MPa. The material temperature at the outlet 22 was within the above-mentioned temperature range.

TABLE 1

| | | | | | | | | Number of | | |
|---|---|---|---|---|---|---|---|---|---|---|
| | | | | | | | | through holes | | |
| | | | | | | S/channel | | per 10 cm² | Length L1 | |
| | | W/through | | | Area S of | cross- | Number of | of channel | (mm) of | |
| | Hole | hole area | Through hole | | through | sectional | rows of | cross- | loosening | |
| | interval | conversion | dimensions (mm) | | hole | area Sf | through holes | sectional | unit in X | L1/L5 |
| Plate | W (mm) | radius Y1 | L2 | L3 | mm² | % | Y direction | area | direction | (%) |
| (a) | 0.5 | 0.4 | 2 | 2 | 4 | 0.39 | 8 | 160 | 0.5 | 0.1 |
| (b) | 1.0 | 0.5 | 1 | 4 | 13 | 1.27 | 4 | 40 | 1 | 0.2 |
| (c) | 3.0 | 1.1 | 3 | 8 | 24 | 2.34 | 3 | 15 | 6 | 1.1 |
| (d) | 3.0 | 0.7 | 8.5 | 8 | 52 | 5.08 | 2 | 8 | 6 | 1.1 |
| (e) | 3.0 | 0.5 | 20 | 8 | 128 | 12.50 | 1 | 4 | 6 | 1.1 |
| (f) | 3.0 | 0.3 | 20 | 14.5 | 232 | 22.66 | 1 | 4 | 6 | 1.1 |
| (g) | 6.0 | 1.0 | 14 | 8.5 | 119 | 11.62 | 1 | 5 | 6 | 1.1 |
| (h) | 6.0 | 1.0 | 14 | 8.5 | 119 | 11.62 | 1 | 5 | 12 | 2.2 |

### Comparative Example 1

The procedure was as in Example 1, except that the plate (b) was not installed.

### Examples 2 and 3

The procedure was as in Example 1, except that the plate (b) was changed as shown in Table 2 to plates (d) and (f) in which the through holes 32 were arranged and had dimensions as shown in rows (d) and (f) in Table 1 (see Table 1 for the dimensions).

### Examples 4 to 11

The procedure was as in Example 1, except that the plate (b) was changed as shown in Table 2 to plates (a) to (h) in which the through holes 32 were arranged and had dimensions as shown in rows (a) to (h) in Table 1. Furthermore, the plate installation position was changed from P1 to P2 in FIG. 2. P2 in FIG. 1 refers to a position at which the proportion with respect to the entire length L of the channel 14 is 50%. The procedure was as in Example 1, except for these aspects.

### Examples 12 to 17

The plates shown in Table 2 were installed at the positions P1 and P2, respectively.

### Evaluation

Five expert panelists ate the meat-like food products obtained in Examples 1 to 17 and Comparative Example 1 and evaluated them according to the following evaluation criteria. The average of the evaluation scores is shown in Table 2. In particular, the meat-like food products obtained in each example had a texture similar to that of chicken among livestock meats.

### Softness

5: Remarkably close to that of livestock meat
4: Close to that of livestock meat
3: Somewhat close to that of livestock meat
2: Different from that of livestock meat
1: Significantly different from that of livestock meat

### Looseness

5: Remarkably close to that of livestock meat
4: Close to that of livestock meat
3: Somewhat close to that of livestock meat
2: Different from that of livestock meat
1: Significantly different from that of livestock meat

### Shape Retainability

5: A lump at discharge from the cooling die, and no problem at all in carrying
4: A lump at discharge from the cooling die, but some care is needed in carrying
3: A lump at discharge from the cooling die, but care is needed in carrying
2: Somewhat collapsed at discharge from the cooling die, and difficult to carry
1: Collapsed at discharge from the cooling die

TABLE 2

| | Position of | Com. | | | | | |
|---|---|---|---|---|---|---|---|
| | loosening unit | Ex. 1 | Ex. 1 | Ex. 2 | Ex. 3 | Ex. 4 | Ex. 5 |
| Type | P1 | | b | d | f | | |
| | P2 | | | | | a | b |

| | | | | | | |
|---|---|---|---|---|---|---|
| Softness | 1.0 | 3.3 | 3.1 | 3.0 | 4.6 | 4.4 |
| Looseness | 1.0 | 3.1 | 3.3 | 3.1 | 4.1 | 4.1 |
| Shape retainability | 5.0 | 5.0 | 5.0 | 5.0 | 3.4 | 5.0 |

| | Position of | | | | | | |
|---|---|---|---|---|---|---|---|
| | loosening unit | Ex. 6 | Ex. 7 | Ex. 8 | Ex. 9 | Ex. 10 | Ex. 11 |
| Type | P1 | | | | | | |
| | P2 | c | d | e | f | g | h |

| | | | | | | |
|---|---|---|---|---|---|---|
| Softness | 4.2 | 3.8 | 3.5 | 3.3 | 3.3 | 3.3 |
| Looseness | 3.9 | 3.9 | 3.6 | 3.5 | 3.8 | 3.9 |
| Shape retainability | 5.0 | 5.0 | 5.0 | 5.0 | 4.5 | 3.2 |

| | Position of | | | | | | |
|---|---|---|---|---|---|---|---|
| | loosening unit | Ex. 12 | Ex. 13 | Ex. 14 | Ex. 15 | Ex. 16 | Ex. 17 |
| Type | P1 | b | b | c | d | e | f |
| | P2 | c | b | b | b | b | b |

| | | | | | | |
|---|---|---|---|---|---|---|
| Softness | 4.3 | 4.6 | 4.5 | 4.5 | 4.4 | 4.4 |
| Looseness | 4.0 | 4.5 | 4.4 | 4.4 | 4.3 | 4.2 |
| Shape retainability | 5.0 | 5.0 | 5.0 | 5.0 | 5.0 | 5.0 |

As shown in Table 2, the invention of the present application can provide a meat-like food product with good softness and looseness and a texture similar to that of livestock meat.

### INDUSTRIAL APPLICABILITY

According to the cooling die and method for producing a meat-like food product of the present invention, the meat-like food product can be easily loosened and the hardness of the texture can be effectively improved.

1. A cooling die for producing a meat-like food product, the cooling die being disposed downstream, in an extrusion direction, of an extrusion apparatus that extrudes an introduced protein ingredient as an extrudate with an oriented fibrous structure,
the cooling die having an internal portion having a channel through which the extrudate moves,
the cooling die being configured to cool the extrudate that is moving in the channel, and
the cooling die comprising: a loosening unit that is disposed in a part of the channel in a movement direction of the extrudate,
wherein the loosening unit occupies at least a part of a cross section of the channel in a direction that is orthogonal to the movement direction, and has a plurality of through holes that extend through the loosening unit in the movement direction, and
the extrudate is loosened by passing through the plurality of through holes.

2. The cooling die according to claim 1,
wherein the channel has an outlet from which the extrudate is discharged to the outside of the cooling die, and
the loosening unit is disposed upstream of the outlet in the movement direction.

3. The cooling die according to claim 1,
wherein the channel has an inlet into which the extrudate flows from the extrusion apparatus, and
the loosening unit is disposed in a region across distances, from the inlet, corresponding to 0 to 90% of an entire length of the channel.

4. The cooling die according to claim 3, comprising at least one loosening unit that is disposed in a region across distances, from the inlet, corresponding to 30 to 70% of the entire length of the channel, and further comprising at least one loosening unit that is disposed in a region across distances, from the inlet, corresponding to 0 to 25% of the entire length of the channel.

5. The cooling die according to claim 1, wherein a plurality of the loosening units are arranged spaced apart from each other along the movement direction.

6. The cooling die according to claim 1, wherein an area S of one through hole in a cross section of the loosening unit in a direction that is orthogonal to the movement direction is 0.3 to 40% of a cross-sectional area Sf of the channel taken in the same direction at the location of the through hole.

7. The cooling die according to claim 1, wherein an average value of areas S of the through holes in a cross section of the loosening unit in a direction that is orthogonal to the movement direction is 1 to 300 mm².

8. The cooling die according to claim 1, wherein a ratio (W/Y1) of an interval W between the through holes to an area conversion radius Y1 of a through hole in the loosening unit is 0.2 to 1.4.

9. A method for producing a meat-like food product, using an extrusion apparatus that extrudes an introduced protein ingredient as an extrudate with an oriented fibrous structure and the cooling die according to claim 1.
